(19) United States
(12) Patent Application Publication
(10) Pub. No.: US 2026/0082288 A1
(43) Pub. Date: Mar. 19, 2026

(54) METHOD FOR DETERMINING RADIO LINK FAILURE, AND DEVICE

(71) Applicant: GUANGDONG OPPO MOBILE TELECOMMUNICATIONS CORP., LTD., Dongguan (CN)

(72) Inventors: Yi DING, Dongguan (CN); Zhenshan ZHAO, Dongguan (CN)

(21) Appl. No.: 19/398,933

(22) Filed: Nov. 24, 2025

Related U.S. Application Data
(63) Continuation of application No. PCT/CN2023/111331, filed on Aug. 4, 2023.

(51) Int. Cl. H04W 36/00; H04B 7/06; H04W 72/25; H04W 76/28

(52) U.S. Cl. CPC H04W 36/0079; H04B 7/0626; H04W 72/25; H04W 76/28

(57) ABSTRACT

Provided is a method for determining a radio link failure. The method is performed by a first terminal device. The first terminal device transmits data to a second terminal device over a plurality of carriers using carrier aggregation. The method includes: determining the RLF in a case where a value of a discontinuous transmission counter for at least one target carrier of the plurality of carriers is greater than or equal to a first threshold.

### CROSS-REFERENCE TO RELATED APPLICATION

This application is a continuation of International Application No. PCT/CN2023/111331, filed Aug. 4, 2023, the entire disclosure of which is incorporated herein by reference.

### TECHNICAL FIELD

Embodiments of the present disclosure relate to the technical field of communications, and in particular, relate to a method and an apparatus for determining a radio link failure (RLF), and a device and a storage medium thereof.

### RELATED ART

In sidelink (SL) communications, terminal devices communicate with each other using carrier aggregation (CA).

In this scenario, how the terminal devices determine an RLF requires further research.

### SUMMARY

Embodiments of the present disclosure provide a method and an apparatus for determining an RLF, and a device and a storage medium thereof. The technical solutions are as follows.

In some embodiments of the present disclosure, a method for determining an RLF is provided. The method is performed by a first terminal device, wherein the first terminal device transmits data to a second terminal device over a plurality of carriers using CA. The method includes:
determining the RLF in a case where a value of a discontinuous transmission (DTX) counter for at least one target carrier of the plurality of carriers is greater than or equal to a first threshold.

In some embodiments of the present disclosure, a method for determining an RLF is provided. The method is performed by a first terminal device, wherein the first terminal device transmits data to a second terminal device over a plurality of carriers using CA. The method includes:
determining the RLF in a case where no response to a heartbeat packet on at least one target carrier of the plurality of carriers is received.

In some embodiments of the present disclosure, an apparatus for determining an RLF is provided. The apparatus is disposed in a first terminal device, wherein the first terminal device transmits data to a second terminal device over a plurality of carriers using CA. The apparatus includes:
a processing module, configured to determine the RLF in a case where a value of a DTX counter for at least one target carrier of the plurality of carriers is greater than or equal to a first threshold.

In some embodiments of the present disclosure, an apparatus for determining an RLF is provided. The apparatus is disposed in a first terminal device, wherein the first terminal device transmits data to a second terminal device over a plurality of carriers using CA. The apparatus includes:
a processing module, configured to determine the RLF in a case where no response to a heartbeat packet on at least one target carrier of the plurality of carriers is received.

In some embodiments of the present disclosure, a terminal device is provided. The terminal device includes: a processor and a memory storing at least one computer program, wherein the processor is configured to load and run the at least one computer program to cause the terminal device to perform the method for determining an RLF as described above.

In some embodiments of the present disclosure, a computer-readable storage medium is provided. The computer-readable storage medium stores at least one computer program, wherein the at least one computer program, when loaded and run by a processor, causes the processor to perform the method for determining an RLF as described above.

In some embodiments of the present disclosure, a chip is provided. The chip includes: at least one programmable logic circuit and/or at least one program instruction, wherein the chip, when running, is caused to perform the method for determining an RLF as described above.

In some embodiments of the present disclosure, a computer program product is provided. The computer program product includes at least one computer program stored in a computer-readable storage medium, wherein the at least one computer program, when read from the computer-readable storage medium and executed by a processor, causes the processor to perform the method for determining an RLF as described above.

### BRIEF DESCRIPTION OF DRAWINGS

FIG. 1 is a schematic diagram of a network architecture according to some embodiments of the present disclosure;

FIG. 2 is a schematic diagram of transmission between terminal devices using CA according to some embodiments of the present disclosure;

FIG. 3 is a schematic diagram of hybrid automatic repeat request (HARQ) feedback in SL CA according to some embodiments of the present disclosure;

FIG. 4 is a schematic diagram of transmitting a heartbeat packet by an SL user equipment (UE) according to some embodiments of the present disclosure;

FIG. 5 is a schematic diagram of maintaining a DTX counter in SL CA according to some embodiments of the present disclosure;

FIG. 6 is a flowchart of a method for determining an RLF according to some embodiments of the present disclosure;

FIG. 7 is a schematic diagram of maintaining a DTX counter in a same-carrier feedback mode according to some embodiments of the present disclosure;

FIG. 8 is a schematic diagram of maintaining a DTX counter in a cross-carrier feedback mode according to some embodiments of the present disclosure;

FIG. 9 is a schematic diagram of maintaining a DTX counter in a cross-carrier feedback mode according to some embodiments of the present disclosure;

FIG. 10 is a schematic diagram of carrier reselection according to some embodiments of the present disclosure;

FIG. 11 is a flowchart of a method for determining an RLF according to some embodiments of the present disclosure;

FIG. 12 is a schematic diagram of determining an RLF based on a heartbeat packet according to some embodiments of the present disclosure;

FIG. 13 is a schematic diagram of determining an RLF based on a heartbeat packet according to some embodiments of the present disclosure;

FIG. 14 is a block diagram of an apparatus for determining an RLF according to some embodiments of the present disclosure;

FIG. 15 is a block diagram of an apparatus for determining an RLF according to some embodiments of the present disclosure; and

FIG. 16 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are intended to describe the technical solutions according to the embodiments of the present disclosure more clearly, but do not constitute any limitation on the technical solutions according to the embodiments of the present disclosure. Those of ordinary skilled in the art understand that, with the evolution of the network architecture and the emergence of new service scenarios, the technical solutions according to the embodiments of the present disclosure are also applicable to similar technical problems.

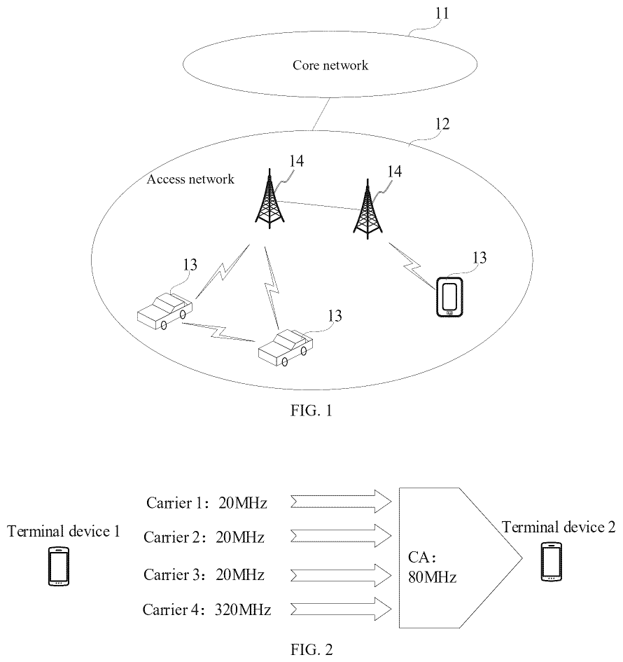

Referring to FIG. 1, a schematic diagram of a network architecture according to some embodiments of the present disclosure is illustrated. The network architecture includes: a core network 11, an access network 12, and terminal devices 13.

The core network 11 includes a plurality of core network devices. The core network devices mainly function to provide user connection, user management, and service bearing, and serve as a bearer network to provide an interface to an external network. For example, the core network of a 5-th generation mobile communication (5G) new radio (NR) system includes devices such as an access and mobility management function (AMF) entity, a user plane function (UPF) entity, and a session management function (SMF) entity.

The access network 12 includes a plurality of access network devices 14. The access network in the 5G NR system may be referred to as a new generation-radio access network (NG-RAN). The access network devices 14 refer to apparatuses deployed in the access network 12 to provide wireless communication functionality for the terminal devices 13. The access network device 14 includes various forms of macro base stations, micro base stations, relay stations, access points, and the like. The name of the device with functionality of an access network device varies in systems employing different radio access technologies. For example, the device is referred to as a gNodeB or a gNB in the 5G NR system. With the evolution of communication technologies, the name “access network device” may change. For the convenience of description, the above apparatuses providing the wireless communication functionality for the terminal devices 13 are collectively referred to as the access network device in the embodiments of the present disclosure.

Typically, a plurality of terminal devices 13 are provided, and one or more terminal devices 13 may be arranged in a cell managed by each of the access network devices 14. The terminal devices 13 may include various handheld devices, in-vehicle devices, wearable devices, computing devices, other processing devices connected to a radio modem with the wireless communication functionality, various forms of user equipments (UEs), mobile stations (MS), and the like. For convenience of description, the devices described above are collectively referred to as the terminal devices. The access network devices 14 communicate with the core network devices using an air interface technology, such as an NG interface in the 5G NR system. The access network devices 14 communicate with the terminal devices 13 using an air interface technology, such as a Uu interface. The “terminal device” in the embodiments of the present disclosure is also referred to as the UE, which have the same meaning.

The terminal devices 13 (for example, the in-vehicle device and another device, such as another in-vehicle device, a mobile phone, or a road side unit (RSU)) may communicate with each other over a direct communication interface (for example, a ProSe communication 5 (PC5) interface). Accordingly, the communication link established based on the direct communication interface may be referred to as a direct link or an SL. The SL transmission means that data transmission is directly carried out between the terminal devices over an SL, which is different from a conventional cellular system in which the communication data is received or transmitted by the access network device. The SL transmission has characteristics of short delay and low overhead, and is therefore suitable for communication between two terminal devices that are geographically close to each other (such as an in-vehicle device and another peripheral device that is geographically close to the in-vehicle device). It should be noted that, in FIG. 1, only vehicle-to-vehicle communication in a vehicle-to-everything (V2X) scenario is illustrated, while the SL communication is applicable to various scenarios where terminal devices directly communicate with each other. In other words, the terminal device in the present disclosure refers to any device that communicates with another device over the SL.

The “5G NR system” in the embodiments of the present disclosure may also be referred to as a 5G system or an NR system, but those skilled in the art can understand the meaning thereof. The technical solutions according to the embodiments of the present disclosure are applicable to the 5G NR system, and also to evolved systems of the 5G NR system.

Before description of the technical solutions of the present disclosure, some related technical knowledge involved in the present disclosure is first explained. The following related technologies may be combined with the technical solutions according to the embodiments of the present disclosure in any manner, all of which fall within the scope of protection of the embodiments of the present disclosure. The embodiments of the present disclosure include at least some of the following content.

### 1. SL Transmission

Regarding the SL transmission, the 3^{rd} Generation Partnership Project (3GPP) has defined two transmission modes: a mode A and a mode B.

In the mode A, transmission resources of the terminal device are allocated by an access network device (such as a base station). The terminal device transmits communication data over the sidelink based on the transmission resources allocated by the access network device. The access network device may allocate transmission resources to the terminal device for single transmission, or allocate transmission resources to the terminal device for semi-static transmission.

In the mode B, the terminal device selects transmission resources from a resource pool autonomously for the transmission of communication data. Specifically, the terminal device may select transmission resources from the resource pool either by sensing or by random selection.

Next, SL communication in NR V2X systems where the terminal device autonomously selects resources (i.e., the mode B described above) is mainly described.

### 2. SL CA

CA is a technology in which a communication device aggregates a plurality of carriers and uses the plurality of carriers simultaneously for data transmission to increase a transmission bandwidth, thereby improving a data transmission rate. In long-term evolution (LTE) V2X, an LTE-based SL CA technology has been supported. In NR SL, support for the SL CA technology is also under consideration, which is intended to both support scenarios requiring a high data transmission rate such as advanced driving and an extended sensor and utilize fragmented spectrum resources to improve spectrum efficiency. For example, FIG. 2 is a schematic diagram of transmission between terminal devices using the CA. A terminal device 1 aggregates four carriers each with a bandwidth of 20 MHz, so as to transmit data to a terminal device 2 over a bandwidth of 80 MHz. Carriers for carrier aggregation may be located in a same band or different bands, which respectively correspond to intra-band CA and inter-band CA. For instance, the carriers 1 to 4 in FIG. 2 may belong to a same band, or may be located in different bands. Meanwhile, sub-carrier spaces (SCS) on the carriers may be the same or different.

3. Carrier reselection in the SL CA

In the LTE V2X, each logical channel corresponds to at least one carrier. In a case where data is present in a logical channel, carrier selection or reselection may be triggered under the following three cases:
(1) No SL transmission resource is deployed on each carrier corresponding to the logical channel.
(2) An SL transmission resource is deployed on a carrier corresponding to the logical channel, and resource selection or resource reselection is triggered on the carrier.
(3) A terminal device transmits a single medium access control (MAC) protocol data unit (PDU).

For ease of understanding, the logical channel may be understood as an interface from a radio link control (RLC) layer to a MAC layer, which bears different services. One MAC PDU may correspond to at least one logical channel. For example, a MAC PDU may be understood as a data packet, and the logical channel may be understood as a channel that carries data of different services contained in the data packet.

In a case where the carrier selection or reselection is triggered, the following operations are performed:

In a case where no SL transmission resource is deployed on each carrier corresponding to the logical channel, for each carrier corresponding to the logical channel, the carrier may be taken as a candidate carrier in a case where a channel busy ratio (CBR) measured on the carrier is less than a threshold U. The threshold U is related to a priority of the logical channel.

Otherwise, in a case where an SL transmission resource is deployed on a carrier corresponding to the logical channel, the carrier selection or reselection is triggered on the carrier. For each logical channel L that has data and is allowed on the carrier, the following operations are performed:

The carrier is selected as a carrier of the logical channel L in a case where a CBR measured on the carrier is less than a threshold Y. The threshold Y is related to a priority of the logical channel L.

Otherwise, for each carrier corresponding to the logical channel L, the carrier may be taken as a candidate carrier of the logical channel L in a case where a CBR measured on the carrier is less than a threshold P. The threshold P is related to the priority of the logical channel L.

After the above operations, in a case where one or more carriers are considered as candidate carriers for each logical channel with data, at least one carrier is selected from the candidate carriers in an ascending order of CBRs of the candidate carriers. A specific quantity of carriers selected depends on a capability of the terminal device.

### 4. HARQ Feedback in the SL CA

In a case where the HARQ feedback is activated, for transmission from a transmitter end, a receiver end feeds back an acknowledgement (ACK) or a negative acknowledgement (NACK) to the transmitter end based on whether reception is successful. The ACK represents successful reception, and the NACK represents failed reception. The receiver end performs the HARQ feedback for the transmitter end via a physical sidelink feedback channel (PSFCH).

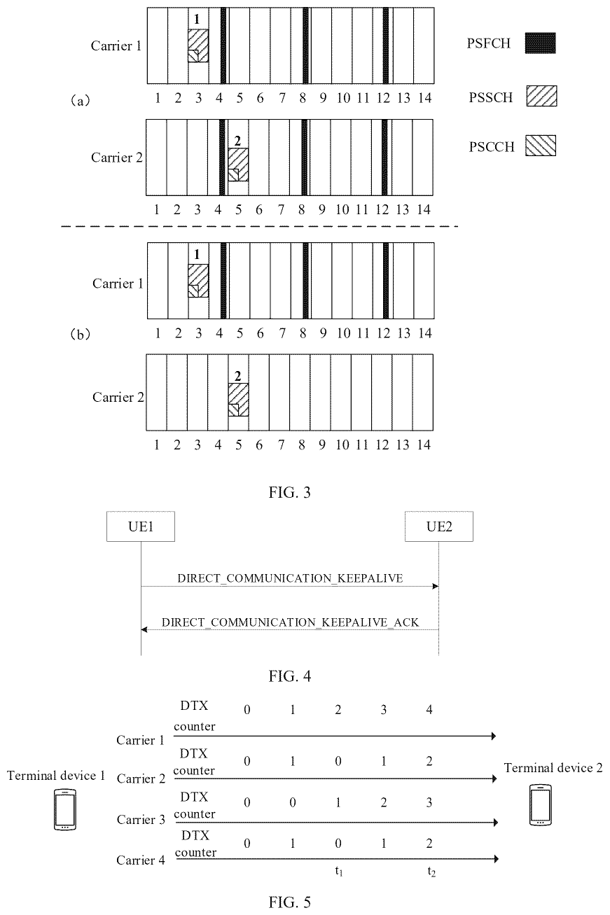

A PSFCH resource is configured for each resource pool. In the NR SL, there are three types of configurations: N=1, N=2, and N=4. N=1 means that the PSFCH resource is configured for each slot in the resource pool; N=2 means that the PSFCH resource is configured for every two slots in the resource pool; and N=4 means that the PSFCH resource is configured for every four slots in the resource pool. In the NR SL, the PSFCH resource is configured in a second-to-last symbol among symbols available for SL transmission within a slot. As illustrated in subfigure (a) of FIG. 3, on a carrier 1 and a carrier 2, assuming that all slots are slots in the resource pool, the PSFCH resource is configured for every four slots.

A corresponding relationship is present between a resource for PSCCH/PSSCH transmission and the PSFCH resource. In a case where a UE 1 transmits data to a UE 2 over a PSSCH resource of a slot t, the UE 2 performs the HARQ feedback for the UE 1 in a slot t+a in response to the data transmission. Herein, a is greater than or equal to k, and the slot t+a contains the PSFCH resource. In the NR SL, k is set to two or three slots. For example, for the carrier 1 in subfigure (a) of FIG. 3, it is assumed that N=4 and k=2. In a case where the UE 1 transmits data to the UE 2 in a slot 1, t+a corresponds to a slot 4, and the UE 2 performs the HARQ feedback for the UE 1 in the slot 4. In a case where the UE 1 transmits data to the UE 2 in a slot 3, t+a corresponds to a slot 8, and the UE 2 performs the HARQ feedback for the UE 1 in the slot 8.

In a CA scenario, the PSFCH resource may be configured on each carrier, or may be configured only on some carriers. Correspondingly, HARQ information may be fed back independently on each carrier, or may be fed back only on some carriers. As illustrated in subfigure (a) of FIG. 3, it is assumed that the UE 1 transmits data to the UE 2 over the carrier 1 and the carrier 2, the PSFCH resource is configured on both the carrier 1 and the carrier 2, N=4, and k=2. In a case where the UE 1 transmits the data to the UE 2 over a resource 1 of the carrier 1, the UE 2 performs the HARQ feedback for the UE 1 on a PSFCH in a slot 8 of the carrier 1. In a case where the UE 1 transmits the data to the UE 2 over a resource 2 of the carrier 2, the UE 2 performs the HARQ feedback for the UE 1 on a PSFCH in a slot 8 of the carrier 2. For another example, as illustrated in subfigure (b) of FIG. 3, it is assumed that the UE 1 transmits the data to the UE 2 over the carrier 1 and the carrier 2, but only the carrier 1 is configured with the PSFCH resource. In this case, the UE 1 separately transmits the data to the UE 2 over the resource 1 of the carrier 1 and the resource 2 of the carrier 2, and the UE 2 returns HARQ feedback information corresponding to the data on the resource 1 and HARQ feedback information corresponding to the data on the resource 2 to the UE 1 on a PSFCH resource in the slot 8 of the carrier 1. It should be noted that in subfigure (a) of FIG. 3, since each carrier performs independent feedback, the PSFCH only needs to carry 1-bit ACK or NACK feedback information. In subfigure (b) of FIG. 3, since data from a plurality of carriers is fed back on a same carrier, the PSFCH may need to carry more than one bit of ACK or NACK feedback information.

5. Radio link monitoring (RLM)/RLF of an SL PC5 interface

For a unicast link, the RLM is an essential function to determine the RLF. That is, in a case where a problem occurs on a link between two UEs, for example, the two UEs are moving away from each other, or the two UEs fail to communicate with each other due to obstruction, a current active link resource and configuration need to be released.

To address this problem, the following solutions are available:
Solution 1: As illustrated in FIG. 4, the two UEs transmit KeepAlive signaling (for example, DIRECT_COMMUNICATION_KEEPALIVE) similar to a heartbeat packet to monitor each other's status. In a case where a peer UE does not respond to the above signaling within a given time period (T4101) (for example, the peer UE fails to return DIRECT_COMMUNICATION_KEEPALIVE_ACK), it indicates that the RLF occurs on the link between the two UEs; otherwise, the link between the two UEs is in a normal state.
Solution 2: Whether the RLF occurs is determined based on a reception status of an HARQ feedback corresponding to data transmission. Specifically, based on whether DTX occurs continuously in the data transmission, a transmitter end determines whether an SL is disconnected.

The DTX means that the transmitter end transmits data, but a receiver end does not receive the data and thus does not transmit the HARQ feedback to the transmitter end; or the receiver end receives the data and transmits the HARQ feedback to the transmitter end, but the transmitter end fails to detect the HARQ feedback. Therefore, from a perspective of the transmitter end, in the above two cases, the transmitter end should have received the HARQ feedback but fails to receive HARQ feedback on a corresponding PSFCH resource.

A DTX counter is maintained between two UEs with a unicast link. In a case where the DTX occurs once, that is, no HARQ feedback is detected on a PSFCH corresponding to a PSSCH, a value of the DTX counter is increased by 1. Otherwise, the DTX counter is set to 0. In a case where the value of the DTX counter reaches a configured threshold, the RLF is considered to have occurred. For example, a value of a DTX counter between the UE 1 and the UE 2 is initially 0, and it is assumed that the configured threshold is 2. In a case where the UE 1 transmits data to the UE 2 on a PSSCH 1 and does not detect an HARQ feedback on a PSFCH 1 corresponding to the PSSCH 1, the value of the DTX counter becomes 1. Afterwards, in a case where the UE 1 transmits data to the UE 2 on a PSSCH 2 and detects an HARQ feedback on a PSFCH 2 corresponding to the PSSCH 2, the value of the DTX counter becomes 0. After that, the UE 1 transmits data to the UE 2 on a PSSCH 3 and a PSSCH 4 in sequence, but does not detect HARQ feedback information on both a PSFCH 3 corresponding to the PSSCH 3 and a PSFCH 4 corresponding to the PSSCH 4. As a result, the value of the DTX counter is increased by 1 each time, eventually reaching 2. At this point, the value of the DTX counter reaches the configured threshold, and the UE 1 determines that the RLF has occurred. From the above examples, it can be observed that the RLF occurs in a case where a consecutive DTX count equals the configured threshold. Therefore, the DTX counter may also be referred to as a “consecutive DTX count” or “consecutive DTX counter”.

The CA in the NR SL is being discussed in a current standard. The discussion is limited to an intra-band CA scenario, and the PSFCH resource is configured independently on each carrier. In response to data transmitted by the transmitter end on each carrier, the receiver end performs the HARQ feedback independently on the carrier. The determination of the RLF is also involved in a CA scenario in the NR SL. It has been agreed in the current standard that DTX counters are respectively maintained for a plurality of carriers, and the RLF is determined in a case where values of the DTX counters for the plurality of carriers all reach the configured threshold.

For example, as illustrated in FIG. 5, a terminal device 1 transmits data to a terminal device 2 using the CA, and DTX counters are respectively maintained on four carriers for carrier aggregation. The RLF is determined in a case where values of the DTX counters for all these carriers all reach the configured threshold. Specifically, it is assumed that the values of the DTX counters for the carriers 1 to 4 are initially 0, and the configured threshold is 2. Due to continuous DTX on the carrier 1, at a time point t1, the value of the DTX counter for the carrier 1 reaches 2, but values of DTX counters for the other carriers do not reach 2. Therefore, the terminal device 1 does not consider that the RLF occurs. In a case where the DTX continuously occurs on the carrier 1, the value of the DTX counter increases to 3 and 4 sequentially. At a time point t2, the values of the DTX counters for the other carriers also reach 2 (that is, the values of the DTX counters for all these carriers reach 2), and the terminal device 1 determines that the RLF occurs.

The above method is currently applicable to an intra-band CA scenario with the HARQ feedback performed independently on each carrier. For inter-band CA and cross-carrier HARQ feedback scenarios, whether the above method needs to be enhanced has not been discussed yet in the standard. Meanwhile, how to apply the method for determining the RLF based on the KeepAlive signaling to the CA scenario has not been discussed in the standard either. In addition, this mechanism has some drawbacks. For instance, on the carrier 1, transmission quality is poor and the DTX occurs all the time, causing the value of the DTX counter to reach the configured threshold, but no DTX occurs on the other carriers. As a result, effective data transmission fails to be achieved on the carrier 1 all the time. However, the terminal device neither reselects a carrier for data transmitted on the carrier 1 in a timely manner nor determines the RLF to release the transmission.

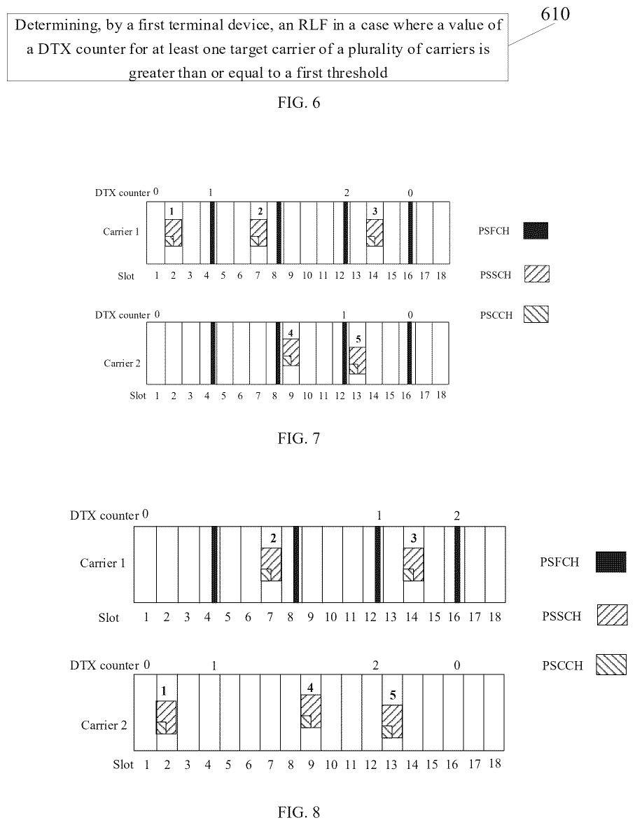

FIG. 6 is a flowchart of a method for determining an RLF according to some embodiments of the present disclosure. The method may be performed by a first terminal device. The method may include the following process.

In process 610, the first terminal device determines the RLF in a case where a value of a DTX counter for at least one target carrier of a plurality of carriers is greater than or equal to a first threshold.

The first terminal device transmits data to a second terminal device over the plurality of carriers using CA. In some embodiments, the plurality of carriers are located in a same band, that is, intra-band CA occurs. In some embodiments, the plurality of carriers are located in different bands, that is, inter-band CA occurs. In some embodiments, a unicast link or a PC5-radio resource control (RRC) link is present between the first terminal device and the second terminal device.

In some embodiments, HARQ feedback information corresponding to the data transmitted by the first terminal device over the plurality of carriers is fed back by the second terminal device on the respective carriers. That is, for data transmitted by the first terminal device on a first carrier, the second terminal device performs HARQ feedback on the first carrier. The first carrier may be any one of the plurality of carriers. This HARQ feedback mode may be referred to as a same-carrier feedback mode.

For example, for data separately transmitted by the first terminal device on carriers 1, 2, and 3, the second terminal device separately performs the HARQ feedback for the first terminal device on the carriers 1, 2, and 3 correspondingly. Specifically, for the data transmitted by the first terminal device to the second terminal device over the carrier 1, the second terminal device performs the HARQ feedback for the first terminal device on the carrier 1 correspondingly. For the data transmitted by the first terminal device to the second terminal device over the carrier 2, the second terminal device performs the HARQ feedback for the first terminal device on the carrier 2 correspondingly. For the data transmitted by the first terminal device over the carrier 3, the second terminal device performs the HARQ feedback for the first terminal device on the carrier 3 correspondingly.

In some embodiments, HARQ feedback information corresponding to data transmitted by the first terminal device on different carriers of the plurality of carriers may be fed back by the second terminal device on a same carrier. That is, for the data transmitted by the first terminal device on the first carrier, the second terminal device may perform the HARQ feedback on a second carrier. The first carrier and the second carrier may be two different carriers. This HARQ feedback mode may be referred to as a cross-carrier feedback mode.

For example, for the data separately transmitted by the first terminal device on the carriers 1, 2, and 3, the second terminal device performs, on the carrier 1, the HARQ feedback for the data on the carrier 1 and the HARQ feedback for the data on the carrier 2, and performs, on the carrier 3, the HARQ feedback for the data on the carrier 3.

In some embodiments, the above data is carried by a PSSCH, and the HARQ feedback information is carried by a PSFCH. For the same-carrier feedback mode, each PSFCH resource only carries 1-bit feedback information. For the cross-carrier feedback mode, a PSFCH resource is allowed to carry more than one bit of feedback information. That is, the PSFCH resource may carry the 1-bit feedback information or the more than one bit of feedback information.

The first terminal device transmits the data to the second terminal device over the plurality of carriers using the CA. The at least one target carrier is included in the plurality of carriers. One or more target carriers are defined. In some embodiments, the at least one target carrier includes all or part of the plurality of carriers. For example, for the data separately transmitted by the first terminal device to the second terminal device on the carriers 1, 2, and 3, the at least one target carrier may be part of the carriers 1, 2, and 3, for example, the carrier 1 or the carriers 1 and 3. Alternatively, the at least one target carrier may be all of the carriers 1, 2, and 3, that is, the at least one target carrier is the carriers 1, 2, and 3.

In some embodiments, the first terminal device maintains a DTX counter for each carrier on which the CA (in other words, data transmission) is performed. That is, the first terminal device transmits the data to the second terminal device over the plurality of carriers using the CA, and the first terminal device maintains the DTX counter for each of the plurality of carriers. For example, the first terminal device transmits the data to the second terminal device on the carriers 1, 2, and 3, and the first terminal device maintains corresponding DTX counters for the carriers 1, 2, and 3.

In some embodiments, the first terminal device maintains the DTX counter at least on the at least one target carrier. The first terminal device transmits the data to the second terminal device over the plurality of carriers using the CA. In a case where the at least one target carrier is the all of the plurality of carriers, the first terminal device maintains the DTX counter for each carrier on which the CA (in other words, the data transmission) is performed. In a case where the at least one target carrier is the part of the plurality of carriers, the first terminal device may maintain the DTX counter for each carrier on which the CA (in other words, the data transmission) is performed, or may maintain the DTX counter only for the at least one target carrier.

In some embodiments, the first terminal device maintains the DTX counter for the at least one target carrier, and may or may not maintain a DTX counter for a carrier other than the at least one target carrier of the plurality of carriers. Whether to maintain the DTX counter for the carrier other than the at least one target carrier of the plurality of carriers may depend on an implementation of the first terminal device.

For example, the first terminal device transmits the data to the second terminal device on the carriers 1, 2, and 3, and the at least one target carrier is the carrier 1. In this case, the first terminal device may maintain a corresponding DTX counter only for the carrier 1, or maintain corresponding DTX counters for the carrier 1 and at least one other carrier (for example, the carrier 2 and/or the carrier 3).

Additionally, maintaining a DTX counter for a carrier in the present disclosure may also be configuring the DTX counter for the carrier.

In some embodiments, a plurality of target carriers are defined, and the plurality of target carriers may be located in a same band or different bands.

In some embodiments, the at least one target carrier is configured by a network, pre-configured, or predefined in a protocol, or dependent on the implementation of the first terminal device.

In some embodiments, the at least one target carrier is a carrier configured with the PSFCH resource. For example, in a case where the first terminal device transmits the data to the second terminal device over the carriers 1, 2, and 3, and the carriers 1 and 2 are configured with PSFCH resources, the at least one target carrier is the carriers 1 and 2.

In some embodiments, the at least one target carrier is a carrier for synchronization. For example, in a case where the first terminal device transmits the data to the second terminal device over the carriers 1, 2, and 3, and the first terminal device and the second terminal device perform synchronization based on a synchronization signal on the carrier 1, the at least one target carrier is the carrier 1.

In some embodiments, the at least one target carrier is a carrier for CSI measurement and feedback. For example, in a case where the first terminal device transmits the data to the second terminal device over the carriers 1, 2, and 3, the first terminal device transmits a channel state information-reference signal (CSI-RS) on the carrier 1, and the second terminal device performs measurement based on the CSI-RS on the carrier 1 and feeds back CSI on the carrier 1, the at least one target carrier is the carrier 1.

In some embodiments, the at least one target carrier is a primary carrier (or primary cell). For example, in a case where the first terminal device transmits the data to the second terminal device over the carriers 1, 2, and 3, and the carrier 1 is the primary carrier instead of a secondary carrier (or secondary cell), the at least one target carrier is the carrier 1. For example, the first terminal device may transmit configuration signaling over the primary carrier, for example, PC5-RRC signaling. For example, a time-frequency resource on another carrier may be scheduled or indicated on the primary carrier. For example, a signal transmitted by the first terminal device on the primary carrier may be configured to deactivate or activate transmission on another carrier.

In some embodiments, the at least one target carrier includes at least one carrier in each band. For example, in a case where the first terminal device transmits the data to the second terminal device over the carriers 1, 2, and 3, the carriers 1 and 2 are located in a band 1, and the carrier 3 is located in a band 2, the at least one target carrier is the carriers 1 and 3 or the carriers 2 and 3.

In some embodiments, a plurality of target carriers are defined. In a case where values of DTX counters for the plurality of target carriers are all greater than or equal to the first threshold, the first terminal device determines the RLF. The plurality of target carriers correspond to a same first threshold or different first thresholds.

In some embodiments, the first threshold is configured by the network, pre-configured, predefined in the protocol, or dependent on the implementation of the first terminal device.

The following describes a maintenance process of the DTX counter.

In some embodiments, one PSFCH resource corresponds to at least one PSSCH resource. After the first terminal device transmits data on a PSSCH resource, in a case where the first terminal device does not detect HARQ feedback information on a PSFCH resource corresponding to the PSSCH resource, the first terminal device increases a value of a DTX counter for a carrier on which the PSSCH resource or the PSFCH resource corresponding to the PSSCH resource is located. Alternatively, in a case where the first terminal device detects HARQ feedback information on a PSFCH resource corresponding to the PSSCH resource, the first terminal device sets a value of a DTX counter for a carrier on which the PSSCH resource or the PSFCH resource corresponding to the PSSCH resource is located to 0.

In some embodiments, one PSFCH resource corresponds to at least one PSSCH resource. For a PSSCH resource, HARQ feedback information corresponding to data transmitted on the PSSCH resource is transmitted on a PSFCH resource corresponding to the PSSCH resource. Based on this, after transmitting the data on a PSSCH resource, the first terminal device is capable of detecting the HARQ feedback information on the PSFCH resource corresponding to the PSSCH resource.

In some embodiments, for the same-carrier feedback mode described above, one PSFCH resource corresponds to one PSSCH resource, and the one PSFCH resource and the one PSSCH resource corresponding to the one PSFCH resource are located on a same carrier. After the first terminal device transmits the data on the PSSCH resource, in a case where the first terminal device does not detect HARQ feedback information corresponding to the data on the PSFCH resource corresponding to the PSSCH resource, the first terminal device increases the value of the DTX counter for the carrier on which the PSSCH resource or the PSFCH resource corresponding to the PSSCH resource is located by 1. In a case where the first terminal device detects the HARQ feedback information corresponding to the data on the PSFCH resource corresponding to the PSSCH resource, the first terminal device sets the value of the DTX counter for the carrier on which the PSSCH resource or the PSFCH resource corresponding to the PSSCH resource is located to 0. In some embodiments, in a case where the DTX counter is configured or maintained on the carrier on which the PSSCH resource is located and the above conditions are met, the value of the DTX counter is increased by 1 or set to 0.

As illustrated in FIG. 7, the first terminal device maintains DTX counters for the carriers 1 and 2. It is assumed that all slots in FIG. 7 are slots in a resource pool, the PSFCH resource is configured for every four slots, k=2, and values of the DTX counters are initially 0.

For the carrier 1, in a case where the first terminal device transmits data to the second terminal device on a resource 1 in a slot 2 but does not receive HARQ feedback information in a slot 4, the value of the DTX counter becomes 1. In a case where the first terminal device transmits data to the second terminal device on a resource 2 in a slot 7 but does not receive HARQ feedback information in a slot 12, the value of the DTX counter becomes 2. In a case where the first terminal device transmits data to the second terminal device on a resource 3 in a slot 14 and receives HARQ feedback information in a slot 16, the value of the DTX counter becomes 0.

For the carrier 2, in a case where the first terminal device transmits data to the second terminal device on a resource 4 in a slot 9 but does not receive an HARQ feedback in a slot 12, the value of the DTX counter becomes 1. In a case where the first terminal device transmits data to the second terminal device on a resource 5 in a slot 13 and receives HARQ feedback information in a slot 16, the value of the DTX counter becomes 0.

In some embodiments, for the cross-carrier feedback mode described above, one PSFCH resource corresponds to at least one PSSCH resource, and the one PSFCH resource and the at least one PSSCH resource corresponding to the one PSFCH resource are located on different carriers. After the first terminal device transmits the data on a PSSCH resource, in a case where the first terminal device does not detect HARQ feedback information corresponding to the data on the PSFCH resource corresponding to the PSSCH resource, the first terminal device increases the value of the DTX counter for the carrier on which the PSSCH resource is located by 1. In a case where the first terminal device detects the HARQ feedback information corresponding to the data on the PSFCH resource corresponding to the PSSCH resource, the first terminal device sets the value of the DTX counter for the carrier on which the PSSCH resource is located to 0. In some embodiments, in a case where the DTX counter is configured or maintained on the carrier on which the PSSCH resource is located and the above conditions are met, the value of the DTX counter is increased by 1 or set to 0.

As illustrated in FIG. 8, the first terminal device maintains the DTX counters for the carriers 1 and 2. It is assumed that all slots in FIG. 8 are slots in a resource pool, the PSFCH resource is configured for every four slots on the carrier 1, k=2, no PSFCH resource is configured on the carrier 2, and values of the DTX counters are initially 0.

In a case where the first terminal device transmits data to the second terminal device on a resource 1 in a slot 2 of the carrier 2, a PSFCH resource corresponding to the resource 1 is a PSFCH resource in a slot 4 of the carrier 1, and no HARQ feedback information is received on the PSFCH resource in the slot 4 of the carrier 1, the value of the DTX counter for the carrier 2 becomes 1.

The first terminal device transmits data to the second terminal device on a resource 2 in a slot 7 of the carrier 1 and transmits data to the second terminal device on a resource 4 in a slot 9 of the carrier 2. Both the resource 2 and the resource 4 correspond to a PSFCH resource in a slot 12 of the carrier 1, that is, HARQ feedback for the data transmitted on the resource 4 is performed on the carrier 1. In a case where the first terminal device does not detect any HARQ feedback information on the PSFCH resource in the slot 12 of the carrier 1, the value of the DTX counter for the carrier 1 becomes 1, and the value of the DTX counter for the carrier 2 becomes 2.

The first terminal device transmits data to the second terminal device on a resource 3 in a slot 14 of the carrier 1 and transmits data to the second terminal device on a resource 5 in a slot 13 of the carrier 2. Both the resource 3 and the resource 5 correspond to a PSFCH resource in a slot 16 of the carrier 1, that is, HARQ feedback for the data transmitted on the resource 5 is performed on the carrier 1. On the PSFCH resource in the slot 16 of the carrier 1, the first terminal device only detects HARQ feedback information for the data transmitted on the resource 5 and does not detect HARQ feedback information for the data transmitted on the resource 3. Thus, the value of the DTX counter for the carrier 1 becomes 2, and the value of the DTX counter for the carrier 2 becomes 0.

In some embodiments, for the cross-carrier feedback mode described above, one PSFCH resource corresponds to at least one PSSCH resource, and the one PSFCH resource and the at least one PSSCH resource corresponding to the one PSFCH resource are located on different carriers. After the first terminal device transmits the data on a PSSCH resource, in a case where the first terminal device does not detect HARQ feedback information corresponding to any data on the PSFCH resource corresponding to the PSSCH resource, the first terminal device increases the value of the DTX counter for the carrier on which the PSFCH resource corresponding to the PSSCH resource is located. In a case where the first terminal device detects the HARQ feedback information corresponding to any data on the PSFCH resource corresponding to the PSSCH resource, the first terminal device sets the value of the DTX counter for the carrier on which the PSFCH resource corresponding to the PSSCH resource is located to 0. In some embodiments, in a case where the DTX counter is configured or maintained on the carrier on which the PSFCH resource is located and the above conditions are met, the value of the DTX counter is increased or set to 0.

For example, in a case where one PSFCH resource corresponds to N PSSCH resources and HARQ feedback information for data transmission on the N PSSCH resources is not detected, a value of a DTX counter for a carrier on which the one PSFCH resource is located is increased by 1 or N, wherein N is an integer greater than or equal to 1.

For example, in a case where one PSFCH resource corresponds to N PSSCH resources and at least one of HARQ feedback information for data transmission on the N PSSCH resources is detected on the one PSFCH resource, a value of a DTX counter for a carrier on which the one PSFCH is located is set to 0, wherein N is an integer greater than or equal to 1.

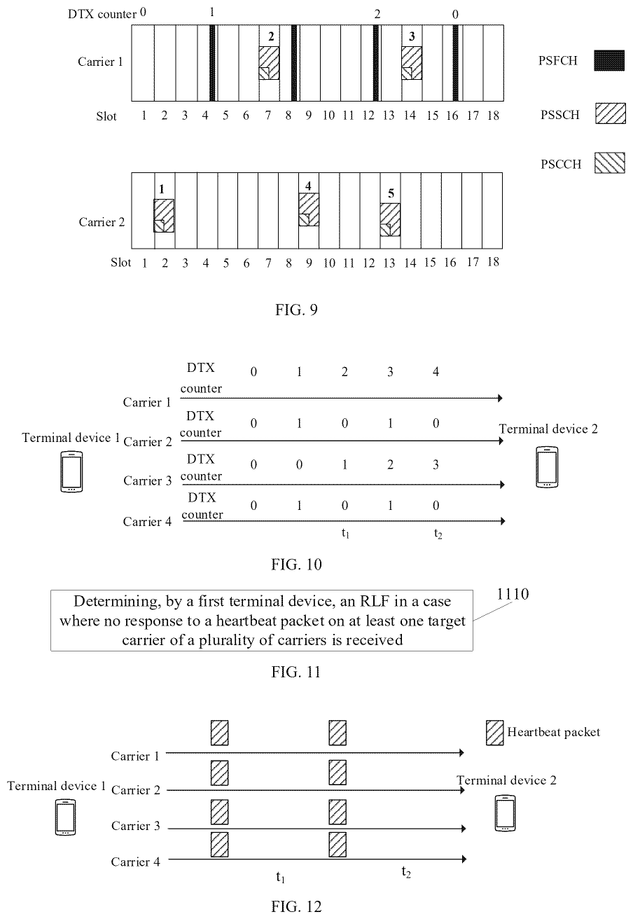

As illustrated in FIG. 9, the first terminal device maintains the DTX counter for the carrier 1. It is assumed that all slots in FIG. 9 are slots in a resource pool, the PSFCH resource is configured for every four slots on the carrier 1, k=2, no PSFCH resource is configured on the carrier 2, and the value of the DTX counter is initially 0.

In a case where the first terminal device transmits data to the second terminal device on a resource 1 in a slot 2 of the carrier 2, a PSFCH resource corresponding to the resource 1 is a PSFCH resource in a slot 4 of the carrier 1, and no HARQ feedback information is received on the PSFCH resource in the slot 4 of the carrier 1, the value of the DTX counter for the carrier 1 becomes 1.

The first terminal device transmits data to the second terminal device on a resource 2 in a slot 7 of the carrier 1 and transmits data to the second terminal device on a resource 4 in a slot 9 of the carrier 2. Both the resource 2 and the resource 4 correspond to a PSFCH resource in a slot 12 of the carrier 1, that is, HARQ feedback for the data transmitted on the resource 4 is performed on the carrier 1. In a case where the first terminal device does not detect any HARQ feedback information on the PSFCH resource in the slot 12 of the carrier 1, the value of the DTX counter for the carrier 1 becomes 2.

The first terminal device transmits data to the second terminal device on a resource 3 in a slot 14 of the carrier 1 and transmits data to the second terminal device on a resource 5 in a slot 13 of the carrier 2. Both the resource 3 and the resource 5 correspond to a PSFCH resource in a slot 16 of the carrier 1, that is, HARQ feedback for the data transmitted on the resource 5 is performed on the carrier 1. In a case where on the PSFCH resource in the slot 16 of the carrier 1, the first terminal device only detects HARQ feedback for the data transmitted on the resource 5 and does not detect HARQ feedback information for the data transmitted on the resource 3, the value of the DTX counter for the carrier 1 becomes 0.

In some embodiments, for any target carrier, in a case where a value of a DTX counter for any target carrier is greater than or equal to a second threshold, the first terminal device triggers carrier reselection.

In some embodiments, in a case where the value of the DTX counter for any target carrier is greater than or equal to the second threshold and a first condition is met, the first terminal device triggers the carrier reselection. The first condition includes: the first terminal device does not determine the RLF, or a value of a DTX counter for at least one other target carrier is less than the first threshold.

In some embodiments, the carrier reselection triggered by the first terminal device is to reselect the at least one target carrier. For example, a transmission carrier is re-determined for data on the at least one target carrier. In some embodiments, the data on the at least one target carrier refers to a logical channel transmitted on the at least one target carrier.

In some embodiments, for any target carrier, after the carrier reselection is triggered, for each carrier corresponding to any logical channel L carried on any target carrier, in a case where a CBR measured on the carrier is less than a threshold U, the carrier is taken as a candidate carrier. The threshold U is related to a priority of the any logical channel. Among determined candidate carriers, a transmission carrier for the any logical channel L is determined in an ascending order of CBRs of the determined candidate carriers. A quantity of determined carriers depends on a capability of the first terminal device. In some embodiments, the determined transmission carrier does not include the at least one target carrier.

In some embodiments, the second threshold is configured by the network, pre-configured, predefined in the protocol, or dependent on the implementation of the first terminal device.

In some embodiments, the second threshold is equal to the first threshold, or the second threshold is greater than the first threshold. In some embodiments, the second threshold is the first threshold, that is, the second threshold and the first threshold are a same threshold, and only one threshold needs to be configured, defined, or determined. In some embodiments, the second threshold and the first threshold are two different thresholds, and the two thresholds need to be configured, defined, or determined. The second threshold may be greater than or equal to the first threshold.

In some embodiments, the second threshold is determined based on the first threshold. For example, the second threshold is obtained by adding a first offset to the first threshold. The first offset may be configured by the network, pre-configured, predefined in the protocol, or dependent on the implementation of the first terminal device.

As illustrated in FIG. 10, the first terminal device transmits data to the second terminal device over carriers 1 to 4. The at least one target carrier is the carriers 1 to 4, and the first terminal device maintains DTX counters for the carriers 1 to 4. The first threshold is 2, and the second threshold is 4. Due to continuous DTX on the carrier 1, at a time point t1, a value of the DTX counter for the carrier 1 reaches the first threshold, but values of the DTX counters for the carriers 2 to 4 do not reach the first threshold. Therefore, the first terminal device does not determine the RLF. At a time point t2, the value of the DTX counter for the carrier 1 reaches the second threshold, but the values of the DTX counters for the carriers 2 to 4 do not reach the first threshold (that is, at the time point t2, the first terminal device still does not determine the RLF). Therefore, the first terminal device reselects the carrier 1. For any logical channel L on the carrier 1, assuming that the any logical channel L corresponds to the carriers 1 to 3 and CBRs measured by the first terminal device on the carriers 1 to 3 are all less than the threshold U, the carriers 1 to 3 are candidate carriers of the any logical channel L. The first terminal device selects the carriers 2 and 3 as transmission carriers for the any logical channel L from the carriers 1 to 3 in an ascending order of the CBRs of the carriers 1 to 3.

The technical solutions according to the embodiments of the present disclosure provide a method for determining an RLF based on a DTX counter in an SL CA scenario, enabling a terminal device to determine whether a multi-carrier link fails and release relevant configurations and resources in a timely manner.

Additionally, corresponding methods for determining an RLF based on a DTX counter are proposed for same-carrier and cross-carrier feedback modes. This enables a terminal device to determine whether a multi-carrier link fails and release relevant configurations and resources in a timely manner in the above two modes.

Furthermore, a carrier reselection mechanism is designed for a scenario in which DTX occurs continuously on a carrier, such that transmission reliability is ensured.

FIG. 11 is a flowchart of a method for determining an RLF according to some embodiments of the present disclosure. The method may be performed by a first terminal device. The method may include the following process 1110.

In process 1110, the first terminal device determines the RLF in a case where no response to a heartbeat packet on at least one target carrier of a plurality of carriers is received.

The first terminal device transmits data to a second terminal device over the plurality of carriers using CA. In some embodiments, the plurality of carriers are located in a same band, that is, intra-band CA occurs. In some embodiments, the plurality of carriers are located in different bands, that is, inter-band CA occurs. In some embodiments, a unicast link or a PC5-RRC link is present between the first terminal device and the second terminal device.

The first terminal device transmits the data to the second terminal device over the plurality of carriers using the CA. The at least one target carrier is included in the plurality of carriers. One or more target carriers are defined. In some embodiments, the at least one target carrier includes all or part of the plurality of carriers. For example, for data separately transmitted by the first terminal device to the second terminal device on carriers 1, 2, and 3, the at least one target carrier may be part of the carriers 1, 2, and 3, for example, the carrier 1 or the carriers 1 and 3. Alternatively, the at least one target carrier may be all of the carriers 1, 2, and 3, that is, the at least one target carrier is the carriers 1, 2, and 3.

In some embodiments, the first terminal device transmits the heartbeat packet over each carrier on which the CA (in other words, data transmission) is performed. That is, the first terminal device transmits the data to the second terminal device over the plurality of carriers using the CA, and the first terminal device transmits the heartbeat packet over each of the plurality of carriers. For example, the first terminal device transmits the data to the second terminal device over the carriers 1, 2, and 3, and the first terminal device separately transmits the heartbeat packet over the carriers 1, 2, and 3.

In some embodiments, the first terminal device transmits the heartbeat packet at least on the at least one target carrier. The first terminal device transmits the data to the second terminal device over the plurality of carriers using the CA. In a case where the at least one target carrier is the all of the plurality of carriers, the first terminal device transmits the heartbeat packet over each carrier on which the CA (in other words, the data transmission) is performed. In a case where the at least one target carrier is the part of the plurality of carriers, the first terminal device may transmit the heartbeat packet over each carrier on which the CA (in other words, the data transmission) is performed, or may transmit the heartbeat packet only over the at least one target carrier.

In some embodiments, the first terminal device transmits the heartbeat packet over the at least one target carrier, and may or may not transmit the heartbeat packet over a carrier other than the at least one target carrier of the plurality of carriers. Whether to transmit the heartbeat packet over the carrier other than the at least one target carrier of the plurality of carriers may depend on an implementation of the first terminal device.

For example, the first terminal device transmits the data to the second terminal device on the carriers 1, 2, and 3, and the at least one target carrier is the carrier 1. In this case, the first terminal device may transmit the heartbeat packet only over the carrier 1, or transmit the heartbeat packet over the carrier 1 and at least one of the other carriers (for example, the carrier 2 and/or the carrier 3).

In some embodiments, the first terminal device periodically transmits the heartbeat packet. For example, the first terminal device periodically transmits the heartbeat packet over the at least one target carrier. A period of the heartbeat packet may be configured by a network, pre-configured, predefined in a protocol, or dependent on the implementation of the first terminal device.

In some embodiments, the heartbeat packet is transmitted in a resource pool.

In some embodiments, in a case where the first terminal device transmits the heartbeat packet over the plurality of carriers, the first terminal device may simultaneously transmit the heartbeat packet over the plurality of carriers, or may transmit the heartbeat packet over at least two of the plurality of carriers at different time points.

In some embodiments, the heartbeat packet is signaling configured to monitor a status of a peer device between communicating parties. For example, the heartbeat packet may be the KeepAlive signaling described above, such as DIRECT_COMMUNICATION_KEEPALIVE. Correspondingly, response information corresponding to the heartbeat packet may be response information corresponding to the KeepAlive signaling, such as DIRECT_COMMUNICATION_KEEPALIVE_ACK. In the embodiments of the present disclosure, there is no restriction on which specific signaling is used as the heartbeat packet. Any signaling that can be configured to monitor the status of the peer device between the communicating parties can be regarded as the heartbeat packet.

In some embodiments, a plurality of target carriers are defined, and the plurality of target carriers may be located in a same band or different bands.

In some embodiments, the at least one target carrier is configured by the network, pre-configured, predefined in the protocol, or dependent on the implementation of the first terminal device.

In some embodiments, the at least one target carrier is a carrier configured with a PSFCH resource. For example, in a case where the first terminal device transmits the data to the second terminal device over the carriers 1, 2, and 3, and the carriers 1 and 2 are configured with PSFCH resources, the at least one target carrier is the carriers 1 and 2.

In some embodiments, the at least one target carrier is a carrier for synchronization. For example, in a case where the first terminal device transmits the data to the second terminal device over the carriers 1, 2, and 3, and the first terminal device and the second terminal device perform synchronization based on a synchronization signal on the carrier 1, the at least one target carrier is the carrier 1.

In some embodiments, the at least one target carrier is a carrier for CSI measurement and feedback. For example, in a case where the first terminal device transmits the data to the second terminal device over the carriers 1, 2, and 3, the first terminal device transmits a CSI-RS on the carrier 1, and the second terminal device performs measurement based on the CSI-RS on the carrier 1 and feeds back CSI on the carrier 1, the at least one target carrier is the carrier 1.

In some embodiments, the at least one target carrier is a primary carrier (or primary cell). For example, in a case where the first terminal device transmits the data to the second terminal device over the carriers 1, 2, and 3, and the carrier 1 is the primary carrier instead of a secondary carrier (or secondary cell), the at least one target carrier is the carrier 1. For example, the first terminal device may transmit configuration signaling over the primary carrier, for example, PC5-RRC signaling. For example, a time-frequency resource on another carrier may be scheduled or indicated on the primary carrier. For example, a signal transmitted by the first terminal device on the primary carrier can be configured to deactivate or activate transmission on another carrier.

In some embodiments, the at least one target carrier includes at least one carrier in each band. For example, in a case where the first terminal device transmits the data to the second terminal device over the carriers 1, 2, and 3, the carriers 1 and 2 are located in a band 1, and the carrier 3 is located in a band 2, the at least one target carrier is the carriers 1 and 3 or the carriers 2 and 3.

In some embodiments, a plurality of target carriers are defined. In a case where no response to the heartbeat packet on the plurality of target carriers is received, the first terminal device determines the RLF. For example, for any target carrier, the first terminal device transmits the heartbeat packet (such as the KeepAlive signaling) to the second terminal device over any target carrier. In a case where the second terminal device does not respond to the heartbeat packet transmitted by the first terminal device within a first time range, it is denoted that no response to the heartbeat packet is received. The first time range is configured by the network, pre-configured, predefined in the protocol, or dependent on the implementation of the first terminal device. That is, in a case where no response to the heartbeat packet on the plurality of target carriers is received, the first terminal device determines the RLF. In some embodiments, the second terminal device responds on the same carrier where the heartbeat packet is received.

As illustrated in FIG. 12, the first terminal device transmits data to the second terminal device over carriers 1 to 4. The at least one target carrier is the carriers 1 to 4. The first terminal device periodically transmits the KeepAlive signaling to the second terminal device on the carriers 1 to 4. At a time point t1, the first terminal device receives no response from the second terminal device for the KeepAlive signaling on the carrier 1, but receives responses from the second device for the KeepAlive signaling on the carriers 2 to 4. Therefore, the first terminal device does not determine the RLF. At a time point t2, the first terminal device receives no response from the second terminal device for the KeepAlive signaling on the carriers 1 to 4, and thus the first terminal device determines the RLF.

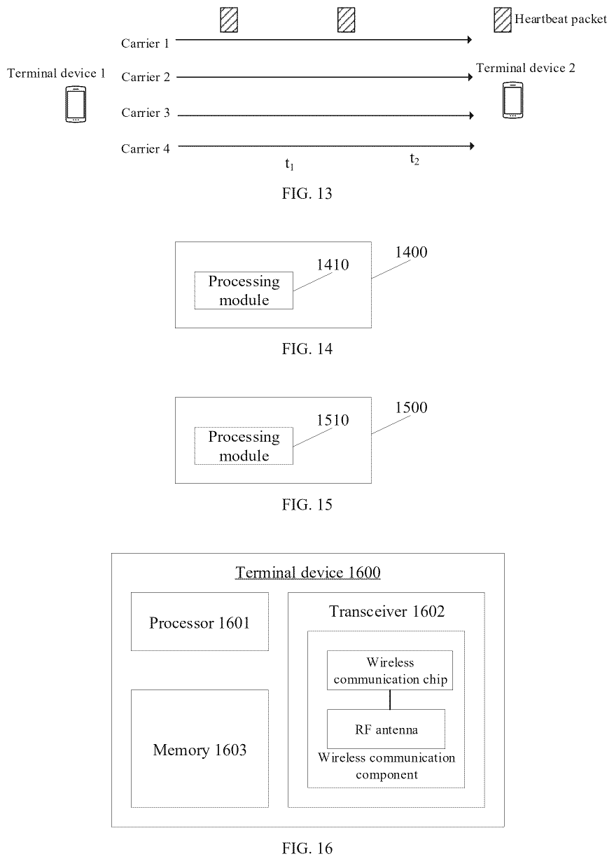

As illustrated in FIG. 13, the first terminal device transmits the data to the second terminal device over the carriers 1 to 4, the at least one target carrier is the carrier 1, and the carrier 1 is the primary carrier. The first terminal device periodically transmits the KeepAlive signaling to the second terminal device over the carrier 1. At the time point t1, the first terminal device receives a response from the second terminal device for the KeepAlive signaling on the carrier 1. Therefore, the first terminal device does not determine the RLF. At the time point t2, the first terminal device receives no response from the second terminal device for the KeepAlive signaling on the carrier 1, and thus the first terminal device determines the RLF.

The technical solutions according to the embodiments of the present disclosure provide a method for determining an RLF based on a heartbeat packet in an SL CA scenario. In the method, a terminal device is capable of determining whether a multi-carrier link fails, such that relevant configurations and resources are released in a timely manner.

The following embodiments are apparatus embodiments of the present disclosure, which may be configured to perform the method embodiments of the present disclosure. For details not disclosed in the apparatus embodiments of the present disclosure, reference may be made to the method embodiments of the present disclosure.

FIG. 14 is a block diagram of an apparatus for determining an RLF according to some embodiments of the present disclosure. The apparatus has function of implementing the above method on a first terminal device side. The function may be implemented by hardware or by hardware executing corresponding software. The apparatus may be the first terminal device described above or may be disposed in the first terminal device. The first terminal device transmits data to a second terminal device over a plurality of carriers using CA. As illustrated in FIG. 14, the apparatus 1400 may include a processing module 1410.

The processing module 1410 is configured to determine the RLF in a case where a value of a DTX counter for at least one target carrier of the plurality of carriers is greater than or equal to a first threshold.

In some embodiments, the at least one target carrier includes all or part of the plurality of carriers.

In some embodiments, the at least one target carrier is a carrier configured with a PSFCH resource; or
the at least one target carrier is a carrier for synchronization; or
the at least one target carrier is a carrier for CSI measurement and feedback; or
the at least one target carrier is a primary carrier; or
the at least one target carrier includes at least one carrier in each band.

In some embodiments, the at least one target carrier is configured by a network, pre-configured, predefined in a protocol, or dependent on an implementation of the first terminal device.

In some embodiments, the DTX counter is maintained at least for the at least one target carrier.

In some embodiments, a plurality of target carriers are defined; and the processing module 1410 is configured to determine the RLF in a case where values of DTX counters for the plurality of target carriers are all greater than or equal to the first threshold.

In some embodiments, the plurality of target carriers correspond to a same first threshold or different first thresholds.

In some embodiments, one PSFCH resource corresponds to at least one PSSCH resource; and the processing module 1410 is further configured to:
after the first terminal device transmits data on a PSSCH resource, performing one of:
in a case where the first terminal device does not detect HARQ feedback information on the PSFCH resource corresponding to the PSSCH resource, increasing a value of a DTX counter for a carrier on which the PSSCH resource or a PSFCH resource corresponding to the PSSCH resource is located; or
in a case where the first terminal device detects HARQ feedback information on the PSFCH resource corresponding to the PSSCH resource, setting a value of a DTX counter for a carrier on which the PSSCH resource or a PSFCH resource corresponding to the PSSCH resource is located to 0.

In some embodiments, one PSFCH resource corresponds to one PSSCH resource, and the one PSFCH resource and the one PSSCH resource corresponding to the one PSFCH resource are located on a same carrier;
the processing module 1410 is configured to: in a case where the first terminal device does not detect HARQ feedback information corresponding to the data on the PSFCH resource corresponding to the PSSCH resource, increase the value of the DTX counter for the carrier on which the PSSCH resource or the PSFCH resource corresponding to the PSSCH resource is located by 1; and
the processing module 1410 is configured to: in a case where the first terminal device detects the HARQ feedback information corresponding to the data on the PSFCH resource corresponding to the PSSCH resource, set the value of the DTX counter for the carrier on which the PSSCH resource or the PSFCH resource corresponding to the PSSCH resource is located to 0.

In some embodiments, one PSFCH resource corresponds to at least one PSSCH resource, and the one PSFCH resource and the at least one PSSCH resource corresponding to the one PSFCH resource are located on different carriers;
the processing module 1410 is configured to: in a case where the first terminal device does not detect HARQ feedback information corresponding to the data on the PSFCH resource corresponding to the PSSCH resource, increase the value of the DTX counter for the carrier on which the PSSCH resource is located by 1; and
the processing module 1410 is configured to: in a case where the first terminal device detects the HARQ feedback information corresponding to the data on the PSFCH resource corresponding to the PSSCH resource, set the value of the DTX counter for the carrier on which the PSSCH resource is located to 0.

In some embodiments, one PSFCH resource corresponds to at least one PSSCH resource, and the one PSFCH resource and the at least one PSSCH resource corresponding to the one PSFCH resource are located on different carriers;
the processing module 1410 is configured to: in a case where the first terminal device does not detect HARQ feedback information corresponding to any data on the PSFCH resource corresponding to the PSSCH resource, increase the value of the DTX counter for the carrier on which the PSFCH resource corresponding to the PSSCH resource is located; and
the processing module 1410 is configured to: in a case where the first terminal device detects the HARQ feedback information corresponding to any data on the PSFCH resource corresponding to the PSSCH resource, set the value of the DTX counter for the carrier on which the PSFCH resource corresponding to the PSSCH resource is located to 0.

In some embodiments, the processing module 1410 is further configured to: for any target carrier, trigger carrier reselection in a case where a value of a DTX counter for any target carrier is greater than or equal to a second threshold.

In some embodiments, the processing module 1410 is configured to trigger the carrier reselection in a case where the value of the DTX counter for any target carrier is greater than or equal to the second threshold and a first condition is met.

The first condition includes: the first terminal device does not determine the RLF, or a value of a DTX counter for at least one other target carrier is less than the first threshold.

In some embodiments, the second threshold is equal to the first threshold, or the second threshold is greater than the first threshold.

In some embodiments, the plurality of carriers are located in a same band or different bands.

FIG. 15 is a block diagram of an apparatus for determining an RLF according to some embodiments of the present disclosure. The apparatus has function of implementing the above method on a first terminal device side. The function may be implemented by hardware or by hardware executing corresponding software. The apparatus may be the first terminal device described above or may be disposed in the first terminal device. The first terminal device transmits data to a second terminal device over a plurality of carriers using CA. As illustrated in FIG. 15, the apparatus 1500 may include a processing module 1510.

The processing module 1510 is configured to determine the RLF in a case where no response to a heartbeat packet on at least one target carrier of the plurality of carriers is received.

In some embodiments, the at least one target carrier includes all or part of the plurality of carriers.

In some embodiments, the at least one target carrier is a carrier configured with a PSFCH resource; or
the at least one target carrier is a carrier for synchronization; or
the at least one target carrier is a carrier for CSI measurement and feedback; or
the at least one target carrier is a primary carrier; or
the at least one target carrier includes at least one carrier in each band.

In some embodiments, the at least one target carrier is configured by a network, pre-configured, predefined in a protocol, or dependent on an implementation of the first terminal device.

In some embodiments, the heartbeat packet is transmitted at least on the at least one target carrier.

In some embodiments, a plurality of target carriers are defined; and the processing module 1510 is configured to determine the RLF in a case where no response to the heartbeat packet on the plurality of target carriers is received.

In some embodiments, the plurality of carriers are located in a same band or different bands.

It should be noted that in a case where the apparatus according to the above embodiments implements its functions, division into the above functional modules is merely used as an example. In practical application, the above functions may be allocated to and completed by different functional modules as required, that is, an internal structure of the apparatus is divided into different functional modules to complete all or part of the above functions.

Specific manners of performing operations by the modules in the apparatus in the above embodiments have been described in detail in the embodiments of the related method, and details are not described herein.

FIG. 16 is a schematic structural diagram of a terminal device according to some embodiments of the present disclosure. The terminal device 1600 may include a processor 1601, a transceiver 1602, and a memory 1603.

The processor 1601 includes at least one processing core. The processor 1601 runs at least one software program and module to run various functional applications and perform information processing. For example, the processor 1601 is configured to implement functions implemented by the processing module in the above apparatus embodiments.

The transceiver 1602 may include a receiver and a transmitter. For example, the receiver and the transmitter may be implemented as a same wireless communication component. The wireless communication component may include a wireless communication chip and a radio frequency (RF) antenna.

The memory 1603 may be connected to the processor 1601 and the transceiver 1602.

The memory 1603 may be configured to store at least one computer program loaded and run by the processor. The processor 1601 is configured to load and run the at least one computer program to implement each step in the above method embodiments.

In some embodiments, for example, the terminal device 1600 is a first terminal device in the above embodiments. The first terminal device transmits data to a second terminal device over a plurality of carriers using CA.

In some embodiments, the processor 1601 is configured to determine an RLF in a case where a value of a DTX counter for at least one target carrier of the plurality of carriers is greater than or equal to a first threshold.

In some embodiments, the processor 1601 is configured to determine the RLF in a case where no response to a heartbeat packet on the at least one target carrier of the plurality of carriers is received.

For details not specified in the embodiments, reference is made to the foregoing embodiments, which are not repeated herein.

In addition, the memory may be implemented by any type or combination of volatile or non-volatile storage devices, including, but not limited to: a magnetic or optical disc, an electrically erasable programmable read-only memory, an erasable programmable read-only memory, a static random-access memory, a read-only memory (ROM), a magnetic memory, a flash memory, and a programmable read-only memory.

The embodiments of the present disclosure further provide a computer-readable storage medium storing one or more computer programs therein. The one or more computer programs, when loaded and run by a processor of a terminal device, cause the terminal device to perform the method for determining an RLF described above.

In some embodiments, the computer-readable storage medium includes: a ROM, a random-access memory (RAM), a solid state drive (SSD), an optical disk, etc. The RAM includes a resistance random-access memory (ReRAM) and a dynamic random access memory (DRAM).

The embodiments of the present disclosure further provide a chip including programmable logic circuitry and/or one or more program instructions. The chip, when running on a terminal device, causes the terminal device to perform the method for determining an RLF described above.

The embodiments of the present disclosure further provide a computer program product. The computer program product includes at least one computer program stored in a computer-readable storage medium. The at least one computer program, when read from the computer-readable storage medium and executed by a processor of a terminal device, causes the terminal device to perform the method for determining an RLF described above.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

The mentioned term “a plurality of” herein means two or more. The term “and/or” describes the association relationship between the associated objects, and indicates that three relationships may be present. For example, the phrase “A and/or B” means (A), (B), or (A and B). The symbol “/”generally indicates an “or”relationship between the associated objects.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for determining a radio link failure (RLF), performed by a first terminal device, wherein the first terminal device transmits data to a second terminal device over a plurality of carriers using carrier aggregation (CA), and the method comprises:
determining the RLF in a case where a value of a discontinuous transmission (DTX) counter for at least one target carrier of the plurality of carriers is greater than or equal to a first threshold.

2. The method according to claim 1, wherein the at least one target carrier comprises all or part of the plurality of carriers;
wherein:
the at least one target carrier is a carrier configured with a physical sidelink feedback channel (PSFCH) resource; or
the at least one target carrier is a carrier for synchronization; or
the at least one target carrier is a carrier for channel state information (CSI) measurement and feedback; or
the at least one target carrier is a primary carrier; or
the at least one target carrier comprises at least one carrier in each band;
wherein the at least one target carrier is configured by a network, is pre-configured, is predefined in a protocol, or is dependent on an implementation of the first terminal device.

3. The method according to claim 1, wherein the DTX counter is maintained at least for the at least one target carrier;
wherein the plurality of carriers are located in a same band, or the plurality of carriers are located in different bands.

4. The method according to claim 1, wherein:
a plurality of target carriers are defined; and
determining the RLF in a case where the value of the DTX counter for the at least one target carrier of the plurality of carriers is greater than or equal to the first threshold comprises:
determining the RLF in a case where values of DTX counters for the plurality of target carriers are all greater than or equal to the first threshold;
wherein the plurality of target carriers correspond to a same first threshold; or the plurality of target carriers correspond to different first thresholds.

5. The method according to claim 1, wherein one PSFCH resource corresponds to at least one physical sidelink shared channel (PSSCH) resource, and the method further comprises:
after the first terminal device transmits data on a PSSCH resource, performing one of:
increasing a value of a DTX counter for a carrier on which the PSSCH resource or a PSFCH resource corresponding to the PSSCH resource is located in a case where the first terminal device does not detect hybrid automatic repeat request (HARQ) feedback information on the PSFCH resource corresponding to the PSSCH resource; or
setting a value of a DTX counter for a carrier on which the PSSCH resource or a PSFCH resource corresponding to the PSSCH resource is located to 0 in a case where the first terminal device detects HARQ feedback information on the PSFCH resource corresponding to the PSSCH resource.

6. The method according to claim 5, wherein one PSFCH resource corresponds to one PSSCH resource, and the one PSFCH resource and the one PSSCH resource corresponding to the one PSFCH resource are located on a same carrier;
increasing the value of the DTX counter for the carrier on which the PSSCH resource or the PSFCH resource corresponding to the PSSCH resource is located in a case where the first terminal device does not detect the HARQ feedback information on the PSFCH resource corresponding to the PSSCH resource comprises:
increasing the value of the DTX counter for the carrier on which the PSSCH resource or the PSFCH resource corresponding to the PSSCH resource is located by 1 in a case where the first terminal device does not detect HARQ feedback information corresponding to the data on the PSFCH resource corresponding to the PSSCH resource; and
setting the value of the DTX counter for the carrier on which the PSSCH resource or the PSFCH resource corresponding to the PSSCH resource is located to 0 in a case where the first terminal device detects the HARQ feedback information on the PSFCH resource corresponding to the PSSCH resource comprises:
setting the value of the DTX counter for the carrier on which the PSSCH resource or the PSFCH resource corresponding to the PSSCH resource is located to 0 in a case where the first terminal device detects the HARQ feedback information corresponding to the data on the PSFCH resource corresponding to the PSSCH resource.

7. The method according to claim 5, wherein one PSFCH resource corresponds to at least one PSSCH resource, and the one PSFCH resource and the at least one PSSCH resource corresponding to the one PSFCH resource are located on different carriers;
increasing the value of the DTX counter for the carrier on which the PSSCH resource or the PSFCH resource corresponding to the PSSCH resource is located in a case where the first terminal device does not detect the HARQ feedback information on the PSFCH resource corresponding to the PSSCH resource comprises:
increasing the value of the DTX counter for the carrier on which the PSSCH resource is located by 1 in a case where the first terminal device does not detect HARQ feedback information corresponding to the data on the PSFCH resource corresponding to the PSSCH resource; and
setting the value of the DTX counter for the carrier on which the PSSCH resource or the PSFCH resource corresponding to the PSSCH resource is located to 0 in a case where the first terminal device detects the HARQ feedback information on the PSFCH resource corresponding to the PSSCH resource comprises:
setting the value of the DTX counter for the carrier on which the PSSCH resource is located to 0 in a case where the first terminal device detects the HARQ feedback information corresponding to the data on the PSFCH resource corresponding to the PSSCH resource.

8. The method according to claim 5, wherein:
one PSFCH resource corresponds to at least one PSSCH resource, and the one PSFCH resource and the at least one PSSCH resource corresponding to the one PSFCH resource are located on different carriers;
increasing the value of the DTX counter for the carrier on which the PSSCH resource or the PSFCH resource corresponding to the PSSCH resource is located in a case where the first terminal device does not detect the HARQ feedback information on the PSFCH resource corresponding to the PSSCH resource comprises:
increasing the value of the DTX counter for the carrier on which the PSFCH resource corresponding to the PSSCH resource is located in a case where the first terminal device does not detect HARQ feedback information corresponding to any data on the PSFCH resource corresponding to the PSSCH resource; and
setting the value of the DTX counter for the carrier on which the PSSCH resource or the PSFCH resource corresponding to the PSSCH resource is located to 0 in a case where the first terminal device detects the HARQ feedback information on the PSFCH resource corresponding to the PSSCH resource comprises:
setting the value of the DTX counter for the carrier on which the PSFCH resource corresponding to the PSSCH resource is located to 0 in a case where the first terminal device detects the HARQ feedback information corresponding to any data on the PSFCH resource corresponding to the PSSCH resource.

9. The method according to claim 1, further comprising:
for any one of the at least one target carrier, triggering carrier reselection in a case where a value of a DTX counter for the any one of the at least one target carrier is greater than or equal to a second threshold;
wherein the second threshold is equal to the first threshold, or the second threshold is greater than the first threshold.

10. The method according to claim 9, wherein triggering the carrier reselection in a case where the value of the DTX counter for the any one of the at least one target carrier is greater than or equal to the second threshold comprises:
triggering the carrier reselection in a case where the value of the DTX counter for the any one of the at least one target carrier is greater than or equal to the second threshold and a first condition is met;
wherein the first condition comprises: the first terminal device not determining the RLF, or a value of a DTX counter for at least one other target carrier being less than the first threshold.

11. A first terminal device, wherein the first terminal device transmits data to a second terminal device over a plurality of carriers using carrier aggregation (CA), and the first terminal device comprises:
a processor; and
a memory storing at least one computer program, which when executed by the processor, causes the first terminal device to:
determine radio link failure (RLF) in a case where a value of a discontinuous transmission (DTX) counter for at least one target carrier of the plurality of carriers is greater than or equal to a first threshold.

12. The first terminal device according to claim 11, wherein one PSFCH resource corresponds to at least one physical sidelink shared channel (PSSCH) resource; and
wherein the at least one computer program, which when executed by the processor, further causes the first terminal device to:
after the first terminal device transmits data on a PSSCH resource, perform one of:
increasing a value of a DTX counter for a carrier on which the PSSCH resource or a PSFCH resource corresponding to the PSSCH resource is located in a case where the first terminal device does not detect hybrid automatic repeat request (HARQ) feedback information on the PSFCH resource corresponding to the PSSCH resource; or
setting a value of a DTX counter for a carrier on which the PSSCH resource or a PSFCH resource corresponding to the PSSCH resource is located to 0 in a case where the first terminal device detects HARQ feedback information on the PSFCH resource corresponding to the PSSCH resource.

13. The first terminal device according to claim 12, wherein one PSFCH resource corresponds to one PSSCH resource, and the one PSFCH resource and the one PSSCH resource corresponding to the one PSFCH resource are located on a same carrier;
wherein the at least one computer program, which when executed by the processor, further causes the first terminal device to:
increase the value of the DTX counter for the carrier on which the PSSCH resource or the PSFCH resource corresponding to the PSSCH resource is located by 1 in a case where the first terminal device does not detect HARQ feedback information corresponding to the data on the PSFCH resource corresponding to the PSSCH resource; and
set the value of the DTX counter for the carrier on which the PSSCH resource or the PSFCH resource corresponding to the PSSCH resource is located to 0 in a case where the first terminal device detects the HARQ feedback information corresponding to the data on the PSFCH resource corresponding to the PSSCH resource.

14. The first terminal device according to claim 12, wherein one PSFCH resource corresponds to at least one PSSCH resource, and the one PSFCH resource and the at least one PSSCH resource corresponding to the one PSFCH resource are located on different carriers;
wherein the at least one computer program, which when executed by the processor, further causes the first terminal device to:
increase the value of the DTX counter for the carrier on which the PSSCH resource is located by 1 in a case where the first terminal device does not detect HARQ feedback information corresponding to the data on the PSFCH resource corresponding to the PSSCH resource; and
set the value of the DTX counter for the carrier on which the PSSCH resource is located to 0 in a case where the first terminal device detects the HARQ feedback information corresponding to the data on the PSFCH resource corresponding to the PSSCH resource.

15. The first terminal device according to claim 12, wherein one PSFCH resource corresponds to at least one PSSCH resource, and the one PSFCH resource and the at least one PSSCH resource corresponding to the one PSFCH resource are located on different carriers;
wherein the at least one computer program, which when executed by the processor, further causes the first terminal device to:
increase the value of the DTX counter for the carrier on which the PSFCH resource corresponding to the PSSCH resource is located in a case where the first terminal device does not detect HARQ feedback information corresponding to any data on the PSFCH resource corresponding to the PSSCH resource; and
set the value of the DTX counter for the carrier on which the PSFCH resource corresponding to the PSSCH resource is located to 0 in a case where the first terminal device detects the HARQ feedback information corresponding to any data on the PSFCH resource corresponding to the PSSCH resource.

16. A first terminal device, wherein the first terminal device transmits data to a second terminal device over a plurality of carriers using carrier aggregation (CA), and the first terminal device comprises:
a processor; and
a memory storing at least one computer program, which when executed by the processor, causes the first terminal device to:
determine radio link failure (RLF) in a case where no response to a heartbeat packet on at least one target carrier of the plurality of carriers is received.

17. The first terminal device according to claim 16, wherein the at least one target carrier comprises all or part of the plurality of carriers;
wherein
the at least one target carrier is a carrier configured with a physical sidelink feedback channel (PSFCH) resource; or
the at least one target carrier is a carrier for synchronization; or
the at least one target carrier is a carrier for channel state information (CSI) measurement and feedback; or
the at least one target carrier is a primary carrier; or
the at least one target carrier comprises at least one carrier in each band;
wherein the at least one target carrier is configured by a network, is pre-configured, is predefined in a protocol, or is dependent on an implementation of the first terminal device.

18. The first terminal device according to claim 16, wherein the heartbeat packet is transmitted at least on the at least one target carrier.

19. The first terminal device according to claim 16, wherein a plurality of target carriers are defined; and
wherein the at least one computer program, which when executed by the processor, further causes the first terminal device to:
determine the RLF in a case where no response to the heartbeat packet on the plurality of target carriers is received.

20. The first terminal device according to claim 16, wherein the plurality of carriers are located in a same band, or the plurality of carriers are located in different bands.
